(19) United States
(12) Patent Application Publication
(10) Pub. No.: US 2016/0088467 A1
(43) Pub. Date: Mar. 24, 2016

(54) SIMULATING MULTI-SIM MULTI-SUBSCRIPTION FUNCTIONALITY ON DIFFERENT MOBILE EQUIPMENT USING SHORT RANGE COMMUNICATION TECHNOLOGIES

(71) Applicant: QUALCOMM Incorporated, San Diego, CA (US)

(72) Inventors: Venkata Konda Reddy Reddem, Hyderabad (IN); Samatha Sudabattula, Hyderabad (IN); Vivek Shankar, San Diego, CA (US)

(21) Appl. No.: 14/495,017

(22) Filed: Sep. 24, 2014

(51) Int. Cl. H04W 8/20; H04W 4/00

(52) U.S. Cl. CPC H04W 8/20; H04W 4/008; H04W 84/18

(57) ABSTRACT

A method for multi-Subscriber Identity Module (SIM) operation on a mobile communication device includes: activating, in a first mobile communication device having a local SIM profile, a client module configured to obtain SIM profile information from a SIM profile of a second mobile communication device; sending a short range communication (SRC) signal to the second mobile communication device causing the second mobile communication device to activate a server module configured to share the SIM profile information of the SIM profile for the second mobile communication device with the first communication device; remotely accessing the shared SIM profile information of the shared SIM profile by the first mobile communication device; and operating the first mobile communication device in a multi-SIM mode using SIM profile information of the local SIM profile and the shared SIM profile information.

### BACKGROUND

Subscriber Identification Modules (SIMs) associate mobile communication devices with subscriptions for voice and data communication services. A user having two or more mobile communication devices which are not multi-SIM capable mobile devices needs to use each of the mobile devices independently and so loses the flexibility of having a multi-SIM mobile device.

Conventional mobile communication devices may allow switching between SIM profiles by physically switching SIMs; in this case only one SIM profile on the device will be active at a time. Other devices may make a single SIM available to mobile communication devices that otherwise do not have a SIM. However, the single SIM can only be active on one device at a time.

### SUMMARY

Apparatuses and methods for multi-SIM multi-subscription functionality by remote sharing of SIM profile information between mobile communication devices are provided.

According to various embodiments there is provided a method for multi-Subscriber Identity Module (SIM) operation on a mobile communication device. The method may include: activating, in a first mobile communication device having a local SIM profile, a client module configured to obtain SIM profile information from a SIM profile of a second mobile communication device; sending a short range communication (SRC) signal to the second mobile communication device causing the second mobile communication device to activate a server module configured to share the SIM profile information of the SIM profile for the second mobile communication device with the first communication device; remotely accessing the shared SIM profile information of the shared SIM profile by the first mobile communication device; and operating the first mobile communication device in a multi-SIM mode using SIM profile information of the local SIM profile and the shared SIM profile information.

According to various embodiments there is provided a mobile communication device. The mobile communication device may include: a short range communication (SRC) unit; a client module configured to communicate via the SRC unit with one or more other mobile communication devices to obtain Subscriber Identity Module (SIM) profile information; and a network communications unit configured to communicate with a communication network associated with SIM profile information of the mobile communication device and with a communication network associated with the obtained SIM profile information.

According to various embodiments there is provided a method for multi-Subscriber Identity Module (SIM) call handling with a shared SIM profile. The method may include: when an incoming call is received on a subscription associated with a local SIM profile: determining whether to disassociate the shared SIM profile from a client device; if a determination is made to disassociate the shared SIM profile, unregistering the shared SIM profile from the client device and conducting the call on the subscription associated with the local SIM; and re-associating the shared SIM profile with the client device when the call on the local SIM is terminated.

According to various embodiments there is provided a method for sharing Subscriber Identity Module (SIM) profile information. The method may include: receiving, at a server device, an association request from a client device via a short range communication (SRC) signal; sending an access grant via an SRC signal to the client device; and making the SIM profile information of the one or more shared SIM profiles remotely available to the client device.

Other features and advantages of the present inventive concept should be apparent from the following description which illustrates by way of example aspects of the present inventive concept.

### BRIEF DESCRIPTION OF THE DRAWINGS

Aspects and features of the present inventive concept will be more apparent by describing example embodiments with reference to the accompanying drawings, in which:

FIG. 1 is a block diagram illustrating a mobile communication device according to various embodiments;

FIG. 2 is a diagram illustrating a client device and a server device according to various embodiments;

FIG. 3 is a flowchart illustrating a method for obtaining a shared SIM profile according to various embodiments;

FIG. 4 is a flowchart illustrating a method for sharing a SIM profile according to various embodiments;

FIG. 5 is a flowchart illustrating a method for call handling according to various embodiments;

FIG. 6 is a flowchart illustrating a method for call handling on a shared SIM for a Multi-SIM, Multi-Active (MSMA) device according to various embodiments; and

FIG. 7 is a flowchart illustrating a method for call handling on a shared SIM for a Multi-SIM, Multi-Standby (MSMS) device according to various embodiments.

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

Various embodiments provide apparatuses and methods for multi-SIM operation on a single-SIM mobile communication device where multiple SIM profiles may be active on the single-SIM mobile communication device.

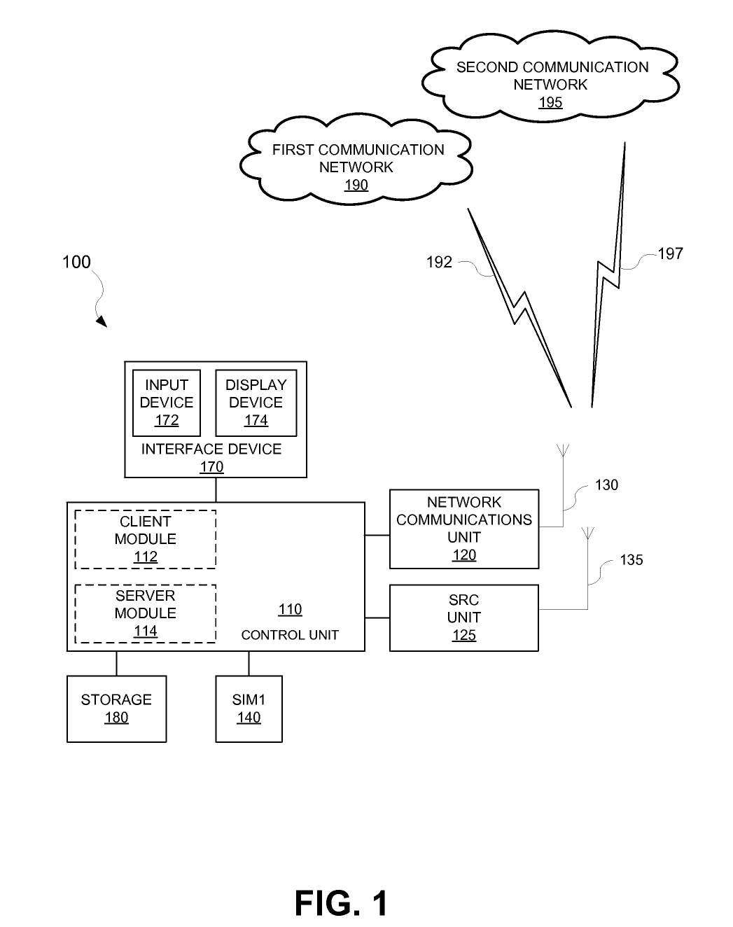

FIG. 1 is a block diagram illustrating a mobile communication device 100 according to various embodiments. As illustrated in FIG. 1, the mobile communication device 100 may include a control unit 110, a network communications unit 120, a short range communication (SRC) unit 125, a first antenna 130, a first SIM 140, a user interface device 170, and a storage 180.

In some embodiments, a mobile communication device 100 may include more than one SIM and may be a Multi-SIM, Multi-Standby (MSMS) or a Multi-SIM, Multi-Active (MSMA) device without departing from the scope of the present inventive concept.

The mobile communication device 100 may be, for example but not limited to, a mobile telephone, smartphone, tablet, computer, etc., capable of communications with one or more wireless networks. One of ordinary skill in the art will appreciate that the mobile communication device 100 may include one or more transceivers (communications units) and may interface with one or more antennas without departing from the scope of the present inventive concept.

The network communications unit 120 may include, for example, but not limited to, a first transceiver (not shown). In active mode, a transceiver receives and transmits signals. In idle mode, a transceiver receives but does not transmit signals. The network communications unit 120 may communicate with a communication network (e.g., the first communication network 190) using any radio access technology (RAT), for example, but not limited to, Wideband Code Division Multiple Access (WCDMA), Global System for Mobile communications (GSM), GSM Enhanced Data rates for GSM Evolution (EDGE) Radio Access Network (GERAN), Long Term Evolution (LTE), WiFi®, etc.

The short range communication (SRC) unit 125 may be configured to communicate with other mobile communications devices using one or more personal area network protocols, for example, but not limited to, near field communication (NFC), Bluetooth®, Bluetooth Smart®, wireless USB, Wi-Fi®, WiFi Direct®, LTE Direct, ANT+, ZigBee®, infrared (IrDA), etc.

The first SIM 140 may associate the network communications unit 120 with a first subscription (Sub1) 192 on a first communication network 190. The first communication network 190 may use any radio access technology, for example, but not limited to, WCDMA, GSM, GERAN, LTE, WiFi®, etc. In active mode, a communications unit receives and transmits signals. In idle mode, a communications unit receives but does not transmit signals.

The user interface device 170 may include an input device 172, for example, but not limited to a keyboard, touch panel, or other human interface device, and a display device 174, for example, but not limited to, a liquid crystal display (LCD), light emitting diode (LED) display, or other video display. One of ordinary skill in the art will appreciate that other input and display devices may be used without departing from the scope of the present inventive concept.

The control unit 110 may be configured to control overall operation of the mobile communication device 100 including control of the network communications unit 120, the SRC unit 125, the user interface device 170, and the storage 180. The control unit 110 may be a programmable device, for example, but not limited to, a microprocessor or microcontroller.

The control unit 110 may include a client module 112 configured to communicate with one or more other mobile communication devices to obtain SIM profile information, and a server module 114 configured to communicate with one or more other mobile communication devices to provide SIM profile information. The client module 112 and/or the server module 114 may be implemented as executable operations programmed into the control unit 110. Alternatively or additionally, the client module 112 and/or the server module 114 may be implemented as electronic circuitry separate from the control unit 110 and/or application-specific circuitry included within the control unit 110. The client module 112 may supply support for multi-SIM (i.e., multi-subscription) operation.

The storage 180 may be configured to store application programs necessary for operation of the mobile communication device 100 that are executed by the control unit 110, as well as application data and user data.

In various embodiments, two or more mobile communication devices that are not multi-SIM capable, i.e., each mobile communication device may physically accommodate only one SIM, may be associated to achieve multi-SIM functionality on one of the mobile communication devices that is selected to be a simulated-multi SIM device.

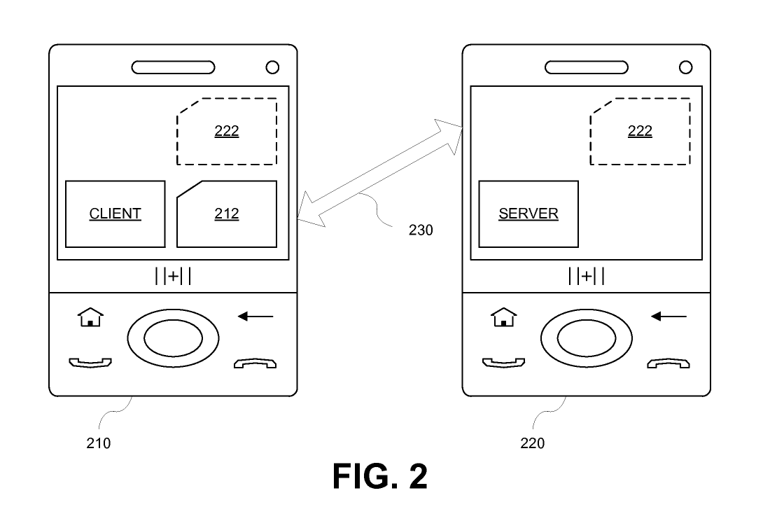

FIG. 2 is a diagram illustrating a client device and a server device according to various embodiments. With reference to FIGS. 1 and 2, a first mobile communication device, referred to herein as a client device 210, may be associated with a second mobile communication device, referred to herein as a server device 220, to remotely share SIM profile information. One of ordinary skill in the art will appreciate that both a client device and a server device may be similarly configured as described with respect to the mobile communication device 100 and therefore the individual configurations the client device 210 in the server device 220′s will not be further described.

The client device 210 may be configured with a local SIM (also referred to herein as a client SIM) 212, and may have support, for example, but not limited to, software and/or firmware known to those of skill in the art, for multi-SIM (i.e., multi-subscription) capability. The server device 220 may be configured with a SIM (also referred to herein as a shared SIM) 222.

The client device 210 and the server device 220 may be linked via a wireless communication link 230 (e.g., via the SRC 125) using personal area network protocols, for example, NFC, Bluetooth®, Bluetooth Smart®, wireless USB, Wi-Fi®, Wi-Fi Direct®, LTE Direct, ANT+, ZigBee®, infrared (IrDA), etc., to enable sharing of SIM profile information, for example, but not limited to, user subscription information, user identity information and security information. The shared SIM profile information may be made remotely available by the server device 220 to the client device 210 permitting the client device 210 to operate as a multi-SIM device utilizing the services (e.g., voice call, data call, SMS, contact list, calendar, etc.) supported by the SIM profile of the shared SIM 222 as well as the services of the client SIM 212.

Supplementary services of the server device 220, for example, but not limited to, call forwarding, call waiting, etc., may be enabled and/or disabled via the client device 210 without affecting services on the client device 210.

When SIM profile information is shared, the server device 220 may disable its own access to the shared SIM profile of the shared SIM 222 and the SIM profile of the shared SIM 222 may be registered to the client device 210 to avoid duplicate registration of the SIM profile. The client device 210 may maintain communication with the server device 220 to access the shared SIM profile information of the shared SIM 222 for network connectivity and other features and/or capabilities of the shared SIM profile that are within the capabilities of the client device 210.

The shared SIM profile information of the shared SIM 222 may enable the client device 210 to communicate with a second communication network 195 via a second subscription 197 according to the shared SIM profile information from the server SIM 222. The second communication network 195 may be operated by the same or different service provider as the first communication network 190 and/or may support the same or different RATs, for example, but not limited to, WCDMA, GSM, GERAN, LTE, WiFi®, etc.

In some embodiments, the client device 210 may include more than one SIM and may be a Multi-SIM, Multi-Standby (MSMS) or a Multi-SIM, Multi-Active (MSMA) device. The multi-SIM client device 210 may have support, for example, but not limited to, software and/or firmware known to those of skill in the art, for multi-SIM (i.e., multi-subscription) capability using one or more shared SIM profiles from a server device 220.

In some embodiments the server device 220 may be a multi-SIM device and may share SIM profile information from more than one SIM with a client device 210. The SIM profiles to be shared by the server device 220 may be determined by presetting selectable options by, for example, but not limited to, input to the input device 172 based on options displayed on the display device 174 on the user interface device 170.

In some embodiments, the server device 220 may be a data card having a modem and a SIM that provides network connectivity or a portable computer having a SIM that provides network connectivity.

In some embodiments, both of the mobile communication devices may be multi-SIM devices having a client module 112 and a server module 114. One of the multi-SIM devices may be configured to operate as a server device 220 by activating the server module 114 to share SIM profile information of one or more SIMs with a another multi-SIM device operating as a client device 210 by activating the client module 112. The SIM profiles to be shared by the server device 220 may be determined by selectable options by, for example, but not limited to, input to the input device 172 based on options displayed on the display device 174 on the user interface device 170 and configuration during device set-up.

In some embodiments, both of the mobile communication devices may be multi-SIM devices having a client module 112 and a server module 114. Each mobile communication device may operate both as a client device 210 and a server device 220 by activating both the client module 112 and the server module 114 in each device will communication. Each mobile communication device may share SIM profile information from one or more SIMs with the other mobile communication device while maintaining operation with at least one unshared SIM that remains registered to each mobile communication device. The SIM profiles to be shared may be determined by presetting selectable options by, for example, but not limited to, input to the input device 172 based on options displayed on the display device 174 on the user interface device 170 and configuration during device set-up.

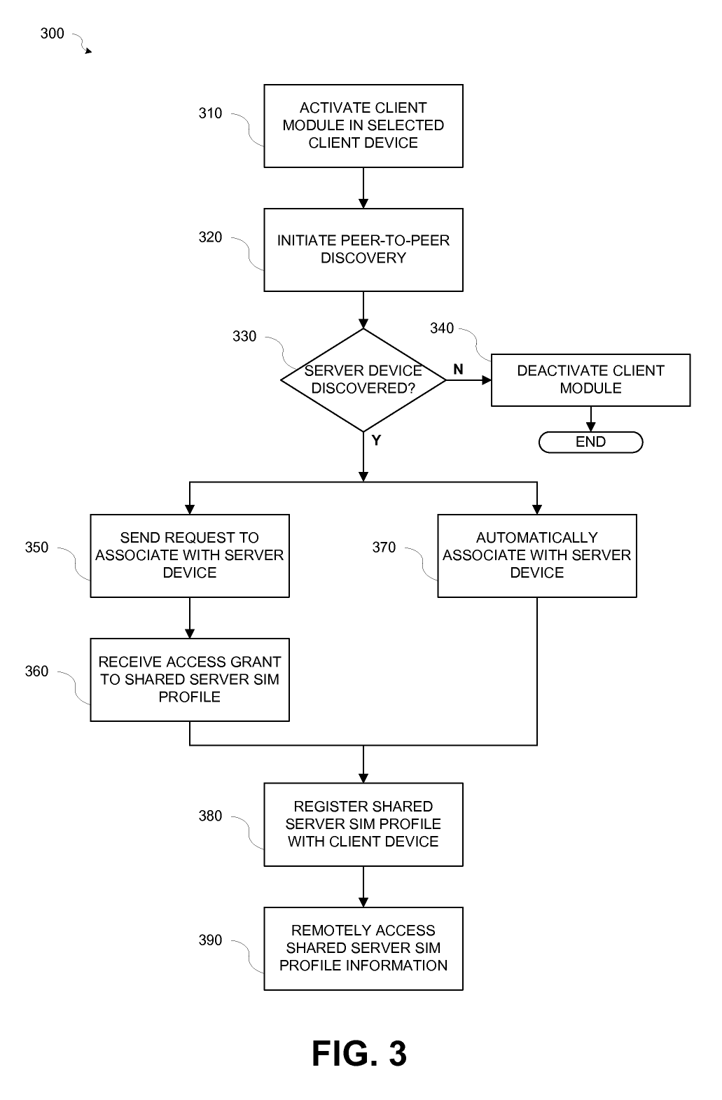

FIG. 3 is a flowchart illustrating a method 300 for obtaining a shared SIM profile according to various embodiments. Referring to FIGS. 1-3, the client module 112 may be activated in a mobile communication device 100 selected for multi-SIM operation (also referred to herein as the client device 210) (310). The client device 210 may be a single-SIM device having software support, for example, but not limited to, software and/or firmware known to those of skill in the art, for multi-SIM (i.e., multi-subscription) capability although the client device 210 may have only 1 physical SIM card slot. Alternatively, the client device 210 may be a multi-SIM device having support, for example, but not limited to, software and/or firmware known to those of skill in the art, for multi-SIM (i.e., multi-subscription) capability using one or more shared SIM profiles.

The control unit 110 of the client device 210 may provide a manual option to activate the client module 112 based on, for example, but not limited to, selecting a menu option using the input device 172 from a menu provided on the display device 174 of the user interface device 170, pressing a dedicated button or key on the input device 172, etc. Upon activation of the client module 112, the control unit 110 of the client device 210 may initiate a discovery process, for example, but not limited to, a peer-to-peer discovery process known in the art, to detect the server device 220 (320). If a server device 220 is not detected (330-N), the control unit 110 may cause the client module 112 to be deactivated (340).

When the server device 220 is detected (330-Y), the control unit 110 of the client device 210 may cause a request signal to be sent to the server device 220 to activate the server module 114 of the server device 220 and associate with the client device 210 (350). The client device 210 may receive a signal from the server device 220 granting access to one or more SIM profiles of the server device 220 (360). Alternatively, if the server device 220 had a previous association with the client device 210, the control unit 110 of the client device 210 may cause the client device 210 to be automatically associated with the server device 220 if the devices are in SRC proximity to each other (370). Both the client device 210 and the server device 220 may provide an indication, for example, an audio or visual indication, of the automatic association. One of ordinary skill in the art will appreciate that various indicators may be provided without departing from the scope of the present inventive concept.

When the client device 210 is associated with the server device 220, the control unit 110 may cause the client device 210 to register the shared SIM profile of the shared SIM 222 to itself (380) and remotely access the SIM profile information of the shared SIM 222 made available from the server device 220 as required for network connectivity and other features and/or capabilities of the shared SIM profile (390). The SIM profile information may be shared wirelessly by, for example, but not limited to, NFC, Bluetooth®, Bluetooth Smart®, wireless USB, WiFi®, Wi-Fi Direct®, LTE Direct, ANT+, ZigBee®, infrared (IrDA), or any other personal area network (PAN) protocol. Accordingly, the client device 210 may be operated in a multi-SIM mode using SIM profile information of the local SIM profile of the client/local SIM 212 and the shared SIM profile of the shared SIM 222.

In some embodiments, the method 300 may be carried out by one client device 210 to associate with a plurality of server devices 220 to share a plurality of SIM profiles. In some embodiments, the method 300 may be carried out by one client device 210 to share a plurality of SIM profiles provided by one server device 220.

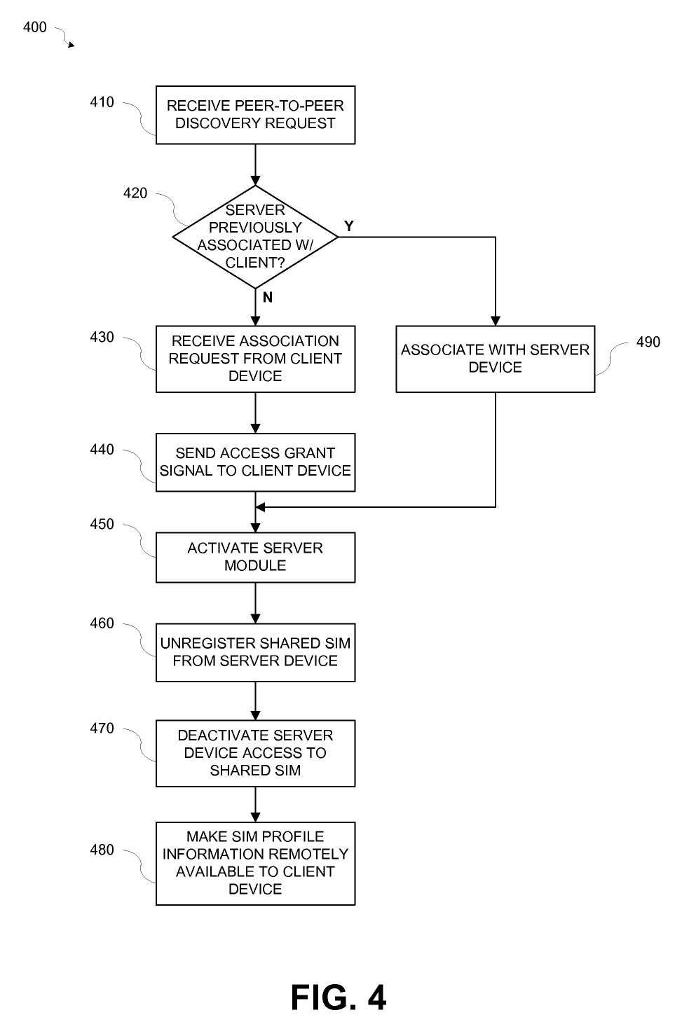

FIG. 4 is a flowchart illustrating a method 400 for sharing a SIM profile according to various embodiments. Referring to FIGS. 1-4, the server device 220 may receive peer-to-peer discovery requests from the client device 210 (410). If the server device 220 has not been previously associated with the client device 210 (420-N), the server device 220 may receive an association request from the client device 210 (430) and may send a signal granting access to SIM profile information of the shared SIM 222 to the client device 210 (440).

The server device 220 may activate the server module 114 (450), unregister the SIM profile to be shared (460), and deactivate its own access to the SIM profile to be shared with the client device 210 (470). The server device 220 may make the SIM profile information of the shared SIM 222 available to the client device 210 for remote access (480). The SIM profile information may be shared wirelessly by, for example, but not limited to, NFC, Bluetooth®, Bluetooth Smart®, wireless USB, WiFi®, Wi-Fi Direct®, LTE Direct, ANT+, ZigBee®, infrared (IrDA), or any other personal area network (PAN) protocol.

If the server device 220 has been previously associated with the client device 210 (420-Y), the server device 220 may associate with the client device 210 (490). The server device 220 may associate with the client device 210. Alternatively, the client device 210 and/or the server device 220 may prompt a user to associate the server device 220 with the client device 210.

The server device 220 may unregister the SIM profile of the shared SIM 222 (460), and deactivate its own access to the SIM profile of the shared SIM 222 (470). The server device 220 may then make the SIM profile information of the shared SIM 222 available to the client device 210 for remote access (480). The SIM profile information may be shared wirelessly by, for example, but not limited to, NFC, Bluetooth®, Bluetooth Smart®, wireless USB, WiFi®, Wi-Fi Direct®, LTE Direct, ANT+, ZigBee®, infrared (IrDA), or any other personal area network (PAN) protocol.

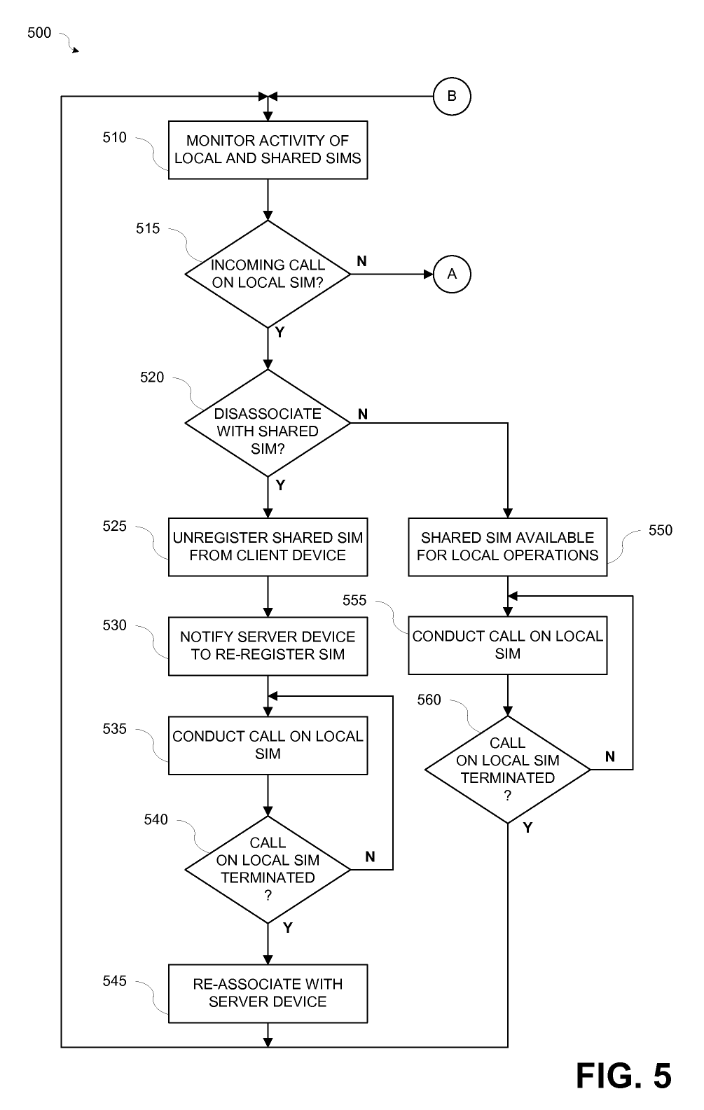

FIG. 5 is a flowchart illustrating a method 500 for call handling according to various embodiments. Referring to FIGS. 1-5, the control unit 110 may monitor the activity of the client SIM 212 and the shared SIM 222 (510). If an incoming call is received on the client SIM 212 (515-Y), the control unit 110 of the client device 210 may determine whether to disassociate with the shared SIM 222 (520). In some embodiments, the control unit 110 may cause the client device 210 to automatically disassociate from SIM profile of the shared SIM 222. In some embodiments, the control unit 110 may provide a manual option to disassociate the client device 210 from SIM profile of the shared SIM 222 based on, for example, but not limited to, selecting a menu option using the input device 172 from a menu provided on the display device 174 of the user interface device 170, pressing a dedicated button on the input device 172, etc.

If a determination to disassociate with the shared SIM 222 is made (520-Y), the control unit 110 of the client device 210 may unregister the SIM profile of the shared SIM 222 from the client device 210 (525) and send a notification signal to the server device 220 to re-register the SIM profile of the shared SIM 222 to the server device 220 (530). The incoming call on the client SIM 212 may then be conducted (535). If the control unit 110 determines that the call has not been terminated (540-N), the control unit 110 may cause the client device 210 to maintain the call on the client SIM 212 (535).

If the control unit 110 determines that the call on the client SIM 212 has been terminated (540-Y), the control unit 110 may cause the client device 210 to re-associate (e.g., automatically) with the server device 220 to share the SIM profile of the shared SIM 222 (545) and may continue to monitor the activity of the client SIM 212 and the shared SIM 222 (510).

If an incoming call is received on the client SIM (515-Y) and a determination is made by the control unit 110 of the client device 210 not to disassociate with the shared SIM 222 (520-N), the shared SIM 222 may remain available to perform local operations not requiring network connectivity, for example, but not limited to, contact list, calendar, etc., supported by the SIM profile of the shared SIM 222 (550), while the call is conducted on the client SIM 212 (555).

If the control unit 110 determines that the call has not been terminated (560-N), the control unit 110 may cause the client device 210 to maintain the call on the client SIM 212 (555). If the control unit 110 determines that the call on the client SIM 212 has been terminated (560-Y), the control unit 110 may continue to monitor the activity of the client SIM 212 and the shared SIM 222 (510).

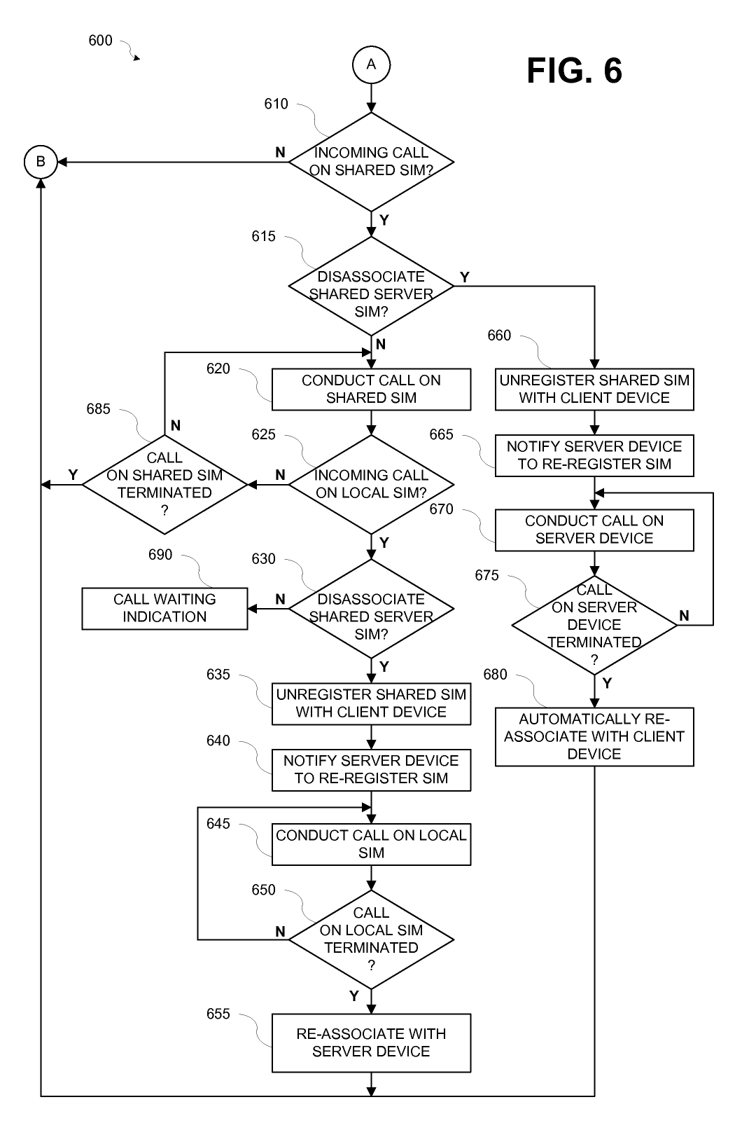

FIG. 6 is a flowchart illustrating a method 600 for call handling on a shared SIM for an MSMA device according to various embodiments. Referring to FIGS. 1-6, if the client device 210 is an MSMA device and an incoming call has not been received on the client SIM 212 (515-N) or on the shared SIM 222 (610-N), the control unit 110 may continue to monitor the activity of the client SIM 212 and the shared SIM 222 (510).

If an incoming call is received on the shared SIM 222 (610-Y), the control unit 110 of the client device 210 may determine whether to disassociate with the shared SIM 222 (615). If a determination is made not to disassociate with the shared SIM 222 (615-N), the client device 210 may conduct the call on the shared SIM 222 (620). Since the client device 210 is an MSMA device, an incoming call may be received on the client SIM 212 during an active call on the shared SIM 222.

If an incoming call is received on the client SIM 212 (625-Y), the control unit 110 of the client device 210 may determine whether to disassociate with the shared SIM 222 (630). If a determination is made not to disassociate with the shared SIM 222 (630-N), the control unit 110 may cause the user interface device 170 to provide a call waiting and/or missed call indication (690). One of ordinary skill in the art will appreciate that the provided indication may be any type of audio and/or video indication.

If a determination is made to disassociate with the shared SIM 222 (630-Y), for example, to continue the active call on the shared SIM 222 using the server device 220, the control unit 110 of the client device 210 may unregister the shared SIM 222 form the client device 210 (635) and may notify the server device 220 to re-register the shared SIM 222 (640). The server device 220 may re-register the shared SIM 222 and the active call on the shared SIM 222 may be conducted on the server device 220 (645).

If the call on the client SIM 212 has not been terminated (650-N), the server device 220 may maintain the call on the client SIM 212 (645). If the call on the client SIM 212 has been terminated (650-Y), the control unit 110 of the client device 210 may cause the client device 210 to re-associate (e.g., automatically) with the server device 220 to share the SIM profile of the shared SIM 222 (655). The client device 210 may continue to monitor the activity of the client SIM 212 and the shared SIM 222 (510).

If a call is not received on the client SIM 212 while a call is conducted on the shared SIM 222 (625-N) and the call on the shared SIM 222 has not been terminated (685-N), the client device 210 may maintain the call on the shared SIM 222 (620). If the call on the shared SIM 222 has been terminated (685-Y), the client device 210 may continue to monitor the activity of the client SIM 212 and the shared SIM 222 (510).

If an incoming call is received on the shared SIM 222 (610-Y) and a determination is made to disassociate with the shared SIM 222 (615-Y), for example, to conduct the incoming call on the shared SIM 222 using the server device 220, the control unit 110 of the client device 210 may unregister the shared SIM 222 from the client device 210 (660) and may notify the server device 220 to re-register the shared SIM 222 (665). The server device 220 may re-register the shared SIM 222 and the incoming call on the shared SIM 222 may be conducted on the server device 220 (670).

If the call on the shared SIM 222 has not been terminated (675-N), the server device 220 may maintain the call on the shared SIM 222 (670). If the call on the shared SIM 222 has been terminated (675-Y), the server device 220 may re-associate (e.g., automatically) with the client device 210 to share the SIM profile of the shared SIM 222 (680). The client device 210 may continue to monitor the activity of the client SIM 212 and the shared SIM 222 (510).

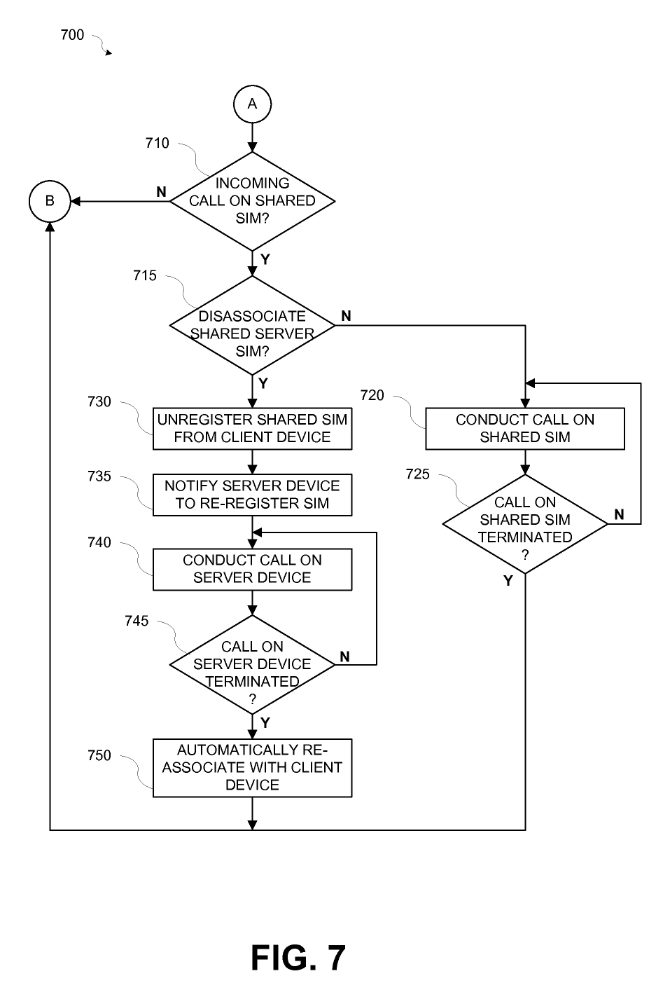

FIG. 7 is a flowchart illustrating a method 700 for call handling on a shared SIM for an MSMS device according to various embodiments. Referring to FIGS. 1-7, if the client device 210 is a MSMS device and an incoming call has not been received on the client SIM 212 (515-N) or on the shared SIM 222 (710-N), the control unit 110 may continue to monitor the activity of the client SIM 212 and the shared SIM 222 (510).

If an incoming call is received on the shared SIM 222 (710-Y), the control unit 110 of the client device 210 may determine whether to disassociate with the shared SIM 222 (715). If a determination is made not to disassociate with the shared SIM 222 (715-N), the client device 210 may conduct the call on the shared SIM 222 (720). Since the client device 210 is an MSMS device, only one of the client SIM 212 and the shared SIM 222 may be active at any time. The control unit 110 of the client device 210 may determine if the call on the shared SIM 222 has been terminated (725).

If the call on the shared SIM 222 has not been terminated (725-N), the client device 210 may maintain the call on the shared SIM 222 (720). If the call on the shared SIM 222 has been terminated (725-Y), the client device 210 may continue to monitor the activity of the client SIM 212 and the shared SIM 222 (510).

If a determination is made to disassociate with the shared SIM 222 (715-Y), for example, to conduct the incoming call on the shared SIM 222 using the server device 220, the control unit 110 of the client device 210 may unregister the shared SIM 222 from the client device 210 (730) and may notify the server device 220 to re-register the shared SIM 222 (735). The server device 220 may re-register the shared SIM 222 and the incoming call on the shared SIM 222 may be conducted on the server device 220 (740).

If the call on the shared SIM 222 has not been terminated (745-N), the server device 220 may maintain the call on the shared SIM 222 (740). If the call on the shared SIM 222 has been terminated (745-Y), the server device 220 may re-associate (e.g., automatically) with the client device 210 to share the SIM profile of the shared SIM 222 (750). The client device 210 may continue to monitor the activity of the client SIM 212 and the shared SIM 222 (510).

In some embodiments, the methods 500, 600, 700 may be carried out by one client device 210 to associate with a plurality of server devices 220 to share a plurality of SIM profiles. In some embodiments, the methods 500, 600, 700 may be carried out by one client device 210 to share a plurality of SIM profiles provided by one server device 220.

In some embodiments, a SIM profile of an embedded SIM that cannot be removed from a mobile communication device 100 may be shared with a client in a diagnostic mode to investigate problems with the embedded SIM.

The accompanying claims and their equivalents are intended to cover such forms or modifications as would fall within the scope and spirit of the protection. For example, the example apparatuses, methods, and systems disclosed herein can be applied to multi-SIM wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A method for multi-Subscriber Identity Module (SIM) operation on a mobile communication device, the method comprising:
activating, in a first mobile communication device having a local SIM profile, a client module configured to obtain SIM profile information from a SIM profile of a second mobile communication device;
sending a short range communication (SRC) signal to the second mobile communication device causing the second mobile communication device to activate a server module configured to share the SIM profile information of the SIM profile for the second mobile communication device with the first communication device;
remotely accessing the shared SIM profile information of the shared SIM profile by the first mobile communication device; and
operating the first mobile communication device in a multi-SIM mode using SIM profile information of the local SIM profile and the shared SIM profile information.

2. The method of claim 1, further comprising registering the shared SIM profile with the first mobile communication device.

3. The method of claim 1, wherein activating the server module causes the second mobile communication device to deactivate its access to the shared SIM profile information and unregister the shared SIM profile.

4. The method of claim 1, wherein the first mobile communication device automatically sends the SRC signal if a second mobile communication device was previously associated with the first mobile communication device and the second mobile communication device is within SRC proximity of the first mobile communication device.

5. The method of claim 1, wherein during an active call on the first mobile communication device on a subscription associated with the local SIM profile, the shared SIM profile information is unavailable for network connectivity.

6. The method of claim 1, wherein during an active call on the first mobile communication device on a subscription associated with the local SIM profile, the shared SIM profile information is available for local operations not requiring network connectivity.

7. The method of claim 1, wherein the shared SIM profile is a SIM profile for an embedded SIM.

8. The method of claim 1, wherein the SRC signal is a Bluetooth signal.

9. A mobile communication device, comprising:
a short range communication (SRC) unit;
a client module configured to communicate via the SRC unit with one or more other mobile communication devices to obtain Subscriber Identity Module (SIM)profile information; and
a network communications unit configured to communicate with a communication network associated with SIM profile information of the mobile communication device and with a communication network associated with the obtained SIM profile information.

10. The mobile communication device of claim 9, further comprising an input device configured to accept an input for initiating the SRC communication.

11. The mobile communication device of claim 10, further comprising a display device configured to display a menu,
wherein input for initiating the SRC communication is based on a selection from the displayed menu.

12. The mobile communication device of claim 10, wherein the input device comprises a dedicated key,
wherein activating the dedicated key initiates the SRC communication.

13. The mobile communication device of claim 9, further comprising a control unit configured to automatically initiate SRC communication with one or more other communication devices within SRC proximity of the mobile communication device if SRC communication with the one or more other communication devices was established at a previous time.

14. The mobile communication device of claim 9, further comprising a server module configured to communicate via the SRC communication unit with another mobile communication device to make SIM profile information remotely available to the other mobile communication device.

15. The mobile communication device of claim 9, wherein the SRC communication unit is a Bluetooth communication unit.

16. A method for multi-Subscriber Identity Module (SIM) call handling with a shared SIM profile, the method comprising:
when an incoming call is received on a subscription associated with a local SIM profile:
determining whether to disassociate the shared SIM profile from a client device;
if a determination is made to disassociate the shared SIM profile, unregistering the shared SIM profile from the client device and conducting the call on the subscription associated with the local SIM; and
re-associating the shared SIM profile with the client device when the call on the local SIM is terminated.

17. The method of claim 16, further comprising:
if a determination is made not to disassociate the shared SIM profile from the client device:
conducting the call on the subscription associated with the local SIM; and
maintaining capability to perform local operations on the client device not requiring network connectivity with the shared SIM.

18. The method of claim 16, further comprising:
when an incoming call is received on a subscription associated with the shared SIM profile:
determining whether to disassociate the shared SIM profile from the client device;
if a determination is made to disassociate the shared SIM profile, unregistering the shared SIM profile from the client device and re-registering the shared SIM profile with a server device;
conducting the call on the subscription associated with the shared SIM on the server device; and
re-associating the shared SIM profile with the client device when the call on server device is terminated.

19. A method for sharing Subscriber Identity Module (SIM) profile information, the method comprising:
receiving, at a server device, an association request from a client device via a short range communication (SRC) signal;
sending an access grant via an SRC signal to the client device; and
making SIM profile information of one or more shared SIM profiles remotely available to the client device.

20. The method of claim 19, further comprising:
activating a server module in the server device;
unregistering one or more SIM profiles to be shared with the client device; and
deactivating local access to SIM profile information of the one or more shared SIM profiles.

21. The method of claim 19, further comprising:
in response to an incoming call on a subscription associated with one of the one or more shared SIM profiles:
receiving at the server device via the SRC signal from the client device a notification to re-register the shared SIM profile with the server device; and
conducting the incoming call on the server device.

22. The method of claim 19, further comprising:
re-associating with the server device; and
making the SIM profile information of the re-associated SIM profile remotely available to the client device.

23. The method of claim 19, wherein the shared SIM profile information is SIM profile information for an embedded SIM.

24. The method of claim 19, wherein the SRC signal is a Bluetooth signal.
